(19) United States
(12) Patent Application Publication
(10) Pub. No.: US 2004/0225553 A1
(43) Pub. Date: Nov. 11, 2004

(54) Measuring customer interest to forecast product consumption

(76) Inventors: George Vincent Broady, San Fransisco, CA (US); Scott R. Bedard, San Fransisco, CA (US)

Correspondence Address: Axiom Legal Solutions, c/o PortfolioIP, P.O. Box 52050, Minneapolis, MN, 55402, US

(21) Appl. No.: 10/429,929

(22) Filed: May 5, 2003

(51) Int. Cl. G06F 17/60

(52) U.S. Cl. 705/10

(57) ABSTRACT

Customer activity (especially activity on Internet web sites) is monitored in correspondence to a product or other entity, in order to enable a forecast of future “consumption” of the product or entity. (Consumption may be the sale, rental, use, viewing or interest in the product or other entity.) First, the monitoring method includes gathering activity information that characterizes the activity of the customers with reference to the entity. Then, the gathered activity information is mapped to a psychographic profile that represents a level of interest of the customers as a function of corresponding phases of a consumption cycle. Finally, the mapped activity information as well as control information (which may include product metadata, customer data, product contextual data) are processed to formulate the forecast of future consumption of the entity. The “product” being monitored may be a physical product, an electronic product such as a computer game or downloadable file, an abstract concept, or a group or category of any of these products. Because the customer activity can be measured and analyzed in near real time, product consumption forecasts are quickly delivered; and use of the control information increases the effective intelligence of the mapping and processing processes, rendering more accurate product consumption forecasts.

### BACKGROUND OF THE INVENTION

1. Field of the Invention

The invention generally relates to arrangements for measuring customer interest in a commercial product or other entity. More particularly, the invention relates to arrangements for measuring the interest of potential customers by mapping their actions to a psychographic profile that is processed to formulate a forecast of future consumption of the product or other entity.

2. Related Art

Many manufactured products, especially software products such as video games, have lengthy, costly and unpredictable development cycles and rapidly evolving competitive sets (competing products). It is desirable that manufacturers be able to accurately forecast the level of customer demand (purchase, or other consumption) during the period leading up to and following a product's launch, as well as how that demand measures up against that of competitive products.

Accurate forecasts of customer demand would permit manufacturers to reduce oversupply (excess inventory) or undersupply (inadequate inventory) of the product or other entity being marketed. Accurate forecasts would also allow manufacturers to assess the sales potential of their products, both in objective terms and in relation to their competitive set, allowing the manufacturers to forecast sales volume. Moreover, this information would allow manufacturers to monitor their success in building and maintaining demand, ultimately allowing them to run more profitable businesses.

Obtaining information on which to forecast sales has been attempted in various ways, primarily using historical sales data as a predictor of future sales. Certain proprietary forecasting systems use historical data and combine it with other inputs, such as type of product, timing of release, marketing programs, and retail distribution plans. Despite their complexity, these forecasting systems are generally not accurate.

Other attempts to obtain information on which to forecast sales include focus groups, surveys, and other traditional research methods of sampling audience preferences. Because these techniques generally rely on small sample sizes and limited numbers of products, and because they require a long time to execute and an additional long time to analyze, these techniques do not produce consistently accurate, useful, or timely results.

Accordingly, there is a need in the art to provide an arrangement by which future consumption of or interest in a product or other entity, or a category thereof, may be quickly, easily and accurately forecast.

### SUMMARY

Accordingly, there is provided a method of monitoring activity of customers with reference to a product or other entity, in order to enable a forecast of future consumption of the entity. The method has the steps of gathering activity information that characterizes the activity of the customers with reference to the entity, mapping the gathered activity information to a psychographic profile that represents a level of interest of the customers as a function of corresponding phases of a consumption cycle, and processing at least the mapped activity information to formulate the forecast of future consumption of the entity.

### BRIEF DESCRIPTION OF THE DRAWINGS

A more complete appreciation of the described embodiments is better understood by reference to the following Detailed Description considered in connection with the accompanying drawings, in which like reference numerals refer to identical or corresponding parts throughout, and in which:

FIG. 1 is a high-level flowchart illustrating basic an embodiment of a method of monitoring activity of customers with reference to an entity (such as a product) in order to enable a forecast of future consumption of the entity;

FIG. 2 illustrates an example of a psychographic profile 210: a measure of a level of customer interest as a function of phase of a consumption cycle 200 of a product or other entity;

FIG. 3 illustrates a data flow diagram corresponding to an embodiment of the method shown in FIG. 1.

FIG. 4 is a flowchart detailing one embodiment of the step 102 (FIG. 1) of gathering activity information of customers;

FIG. 5 is a flowchart detailing one embodiment of the step 104 (FIG. 1) of mapping the activity information to a psychographic profile 210 in phases of a consumption cycle 200;

FIG. 6 is a flowchart detailing one embodiment of the step 106 (FIG. 1) of processing the psychographic profile 210 to forecast future consumption of the product or other entity; and

FIG. 7 is a schematic hardware block diagram of a system that can implement the method of FIG. 1.

### DETAILED DESCRIPTION

In describing embodiments illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose. Various terms that are used in this specification are to be given their broadest reasonable interpretation when used in interpreting the claims.

Moreover, features and procedures whose implementations are well known to those skilled in the art are omitted for brevity. Design and implementation of basic programming functions lies within the ability of those skilled in the art, and accordingly any detailed discussion thereof may be omitted. For example, initiation and termination of software loops lie within the ability of those skilled in the art, and accordingly any detailed discussion thereof may be omitted.

Further, various aspects, features and embodiments may be described in terms of a process that can be depicted as a flowchart, a data flow diagram, a structure diagram, or a block diagram. Although a flowchart may describe the operations as a sequential process, many of the operations can be performed in parallel, concurrently, or in a different order than that illustrated. Operations not needed or desired for a particular implementation may be omitted.

For brevity, the terms “computer” and “computer system” are employed. However, a single unit (box) is not all that these terms are intended to cover. The terms also encompass plural computers that may be arranged in a network.

For brevity, the term “customer” is used. However, this term does not require that the individual have actually made a purchase. As used in this disclosure, “customer” is understood to encompass prospective customers and potential customers.

In this disclosure, embodiments are often described with reference to “products,” such as video games, that are marketed and sold at least in part over the Internet. However, these are merely examples of products, and examples of a marketing and sales approach. Other products and other entities, and other marketing and sales approaches, are applicable.

Further, reference is often made to a “product,” “product-specific” activity, and “product-specific” information. However, these terms are understood to encompass plural entities (such as products in a category) with corresponding activity or information that is specific to those plural entities.

Even more generally, the monitoring and forecasting functions may be applied to “entities” other than commercial products, such as by measuring interest in specific topics to project future levels of interest in those topics. The embodiment can monitor activity among all products or other entities in a category on an ongoing basis, not only products or entities from a particular company or those included in a particular research study.

Thus, as used in this specification, the “consumption” of a “product” is not limited to purchase or rental of a physical or electronic product; rather, consumption may be broadly interpreted as any interest in a given entity, plurality of entities, or category of entities. Accordingly, a variety of different “entities” can be monitored for forecasting interest, including, for example:

individual physical products (for example, a particular book, DVD, or CD)

individual electronic products (for example, a particular downloaded computer game, program, digitally distributed music or movie file, or other file)

plural individual products considered as a set (for example, the five most popular aircraft flight simulator programs, an artist's three most recently released albums, movies directed by a particular individual)

entire classes or categories of products (for example, games on CD as distinguished from downloaded games; books on international politics)

abstract entities or topics (for example, “reality television” programs in general, network television or cable news coverage of wars; in these cases, consumption of the product would involve the customer's merely viewing a program, rather than purchasing or renting a physical or electronic product)

broad concepts (for example, computer games from one or more particular manufacturers or developers; movies about skateboarding; programs for the Macintosh™, and so forth).

The ability to monitor and forecast broad concepts is especially useful when concepts precede actual products. Forecasting broad concepts allows a manufacturer or developer to monitor customers' awareness and consideration for a concept, without being limited or committed to individual products falling under that concept. After products are introduced, the manufacturer or developer would be able to track deeper into the product cycle, which would then augment knowledge about individual products as well as the broader concept.

To illustrate this point, it is assumed that a new operating system is announced. The disclosed monitoring arrangement would begin monitoring news on the development of the new operating system, in effect monitoring customers' awareness and consideration for the operating system. When it is publicized that various specific applications programs that operate on the new operating system are available, they are monitored throughout an entire consumption cycle to gather information for these individual products. Both the levels of activity (news) of the operating system in general, and the information specific to particular applications programs, create an overall score for the operating system. This score can be compared, for example, to an existing operating system to create a realistic forecast for consumption of the new operating system. Also, this information gathering process allows a manufacturer or developer to learn that a particular applications program is driving the majority of purchase demand for the operating system in general.

Thus, the monitoring and forecasting functions disclosed in this specification may be applied to any entity (physical, electronic, or abstract) regarding which relevant data can be gathered and mapped to a customers' psychographic profile and be processed to forecast consumption (purchase, rental, viewing, interest, and so forth) of the entity.

Reference is now made to the accompanying drawings and the following text for a description of particular embodiments.

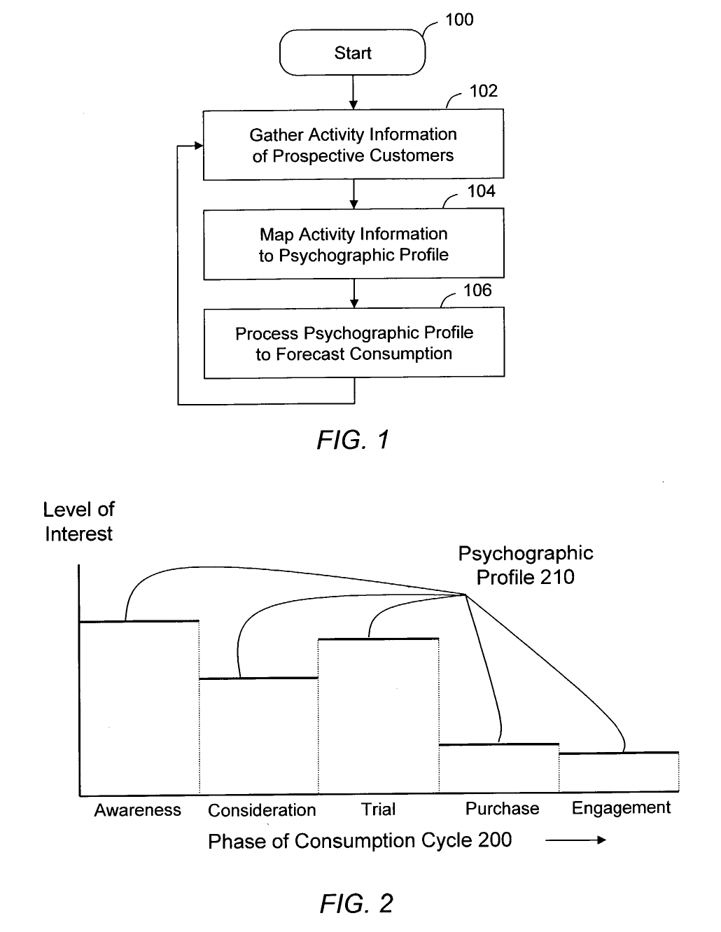

FIG. 1 is a high-level flowchart illustrating basic an embodiment of a method of monitoring activity of customers with reference to a product in order to enable a forecast of future consumption of the product or other entity. The method starts at block 100.

Block 102 represents a step of gathering activity information of customers relating to a product or other entity.

As a basis for one embodiment, it is recognized that extremely large numbers of customers, well into the hundreds of thousands, visit individual Internet web sites each day to obtain product-specific information. This product-specific information may even include information for products that have not yet been launched.

According to this embodiment, the customers' product-specific activity at the web site is monitored, such as by “counting clicks” and tracking the context in which the customers clicked. The information may be categorized and recorded at intervals (such as daily) by an automated system in coordination with unique product identifiers. As such, the monitoring occurs in near real time and makes that information timely, relevant and easy to access.

Besides web site activity, other product-specific activity may be monitored. For example, editorial coverage of the product or category of products may be monitored. Monitored editorials may be at multiple outlets, both online and offline. This monitoring may include the recording of:

the editorial events

the date of the events

the type of events (review, cover story, preview, etc.)

the review scores or ratings

other product-specific editorial coverage information.

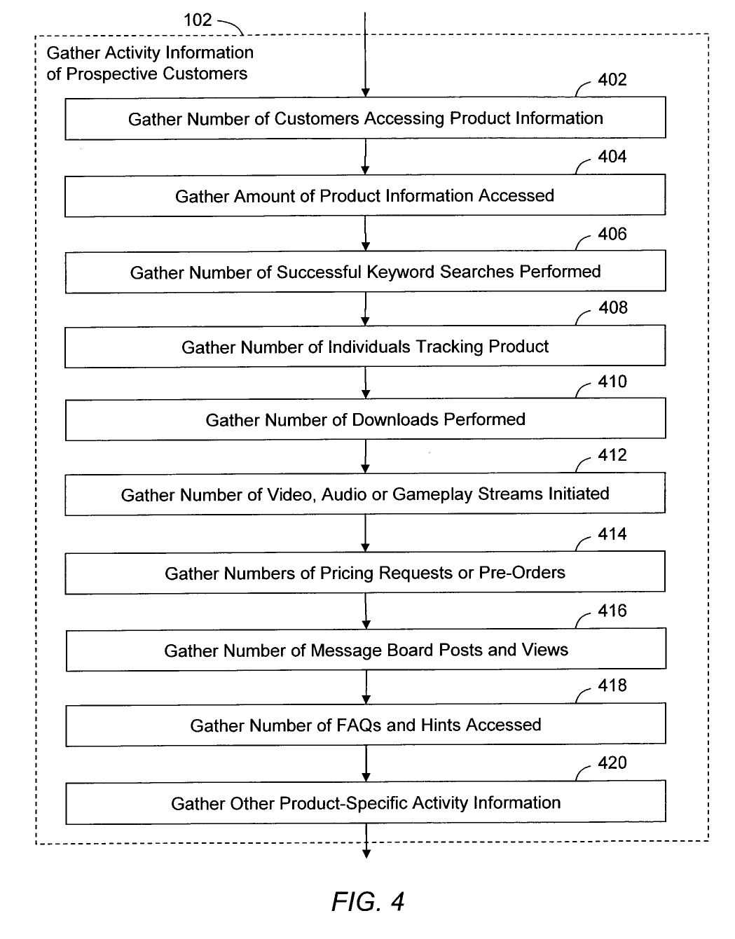

FIG. 4, showing an embodiment of data gathering step 102, is described in greater detail below.

Referring again to FIG. 1, block 104 represents a step of mapping the activity information gathered in step 102 to a psychographic profile 210 (see FIG. 2, discussed below). A psychographic profile represents a measure of the mindset (level of interest) of a customer at respective phases of a consumption cycle 200 (again, see FIG. 2). A consumption cycle 200 may be, for example, a series of phases culminating in the purchase or rental of a physical or electronic product, in the selection and viewing of a topic of interest, in the future interest in an abstract topic, and so forth.

In one example that is shown in FIG. 2, a consumption cycle includes the following phases:

Phase 1: awareness of the product (or product group, or product category, or other entity),

Phase 2: consideration of the product,

Phase 3: trial of the product,

Phase 4: purchase of the product, and

Phase 5: engagement (a phase of the consumption cycle relating to repeat customers). Engagement measures customers' post-consumption affinity for more of the same product, for future versions of the same product, for similar products, and so forth.

As illustrated in FIG. 2, each phase of the consumption cycle 200 (represented on the horizontal axis) has a respective measure (represented on the vertical axis) of the mindset (level of interest) of customers. The measure of the level of interest constitutes the users' psychographic profile 210. In the illustrated representation of the consumption cycle, the phases are arranged as generally chronological steps, but from an analytical perspective a chronological ordering is not necessary.

Although each phase is illustrated as having only a single measured value, it is understood that many items of data may contribute to the this measured value. Accordingly, other examples of psychographic profiles may have more than one value per phase, indicating persistence of the individual data items even beyond the step in which they are mapped to a phase.

Moreover, it is recognized that a given customer need not have to pass through each phase: for example, a customer may consider a product (phase 2) and proceed directly to purchasing the product (phase 4) without trying it first (phase 3). The psychographic profile 210 is generated from the activity of large numbers of customers, and thus the effect of the idiosyncrasies of one individual on the final consumption forecast is minimized. Based on analytic processing techniques described below, it is the composite actions of those large numbers of customers that determines the forecast of consumption.

In one implementation of mapping step 104, the mapping is accomplished by merely storing data in destination storage locations that specifically correspond to a phase of the consumption cycle. In that embodiment, the data is not “tagged” as such.

Accordingly, any process that reads the stored data knows the phase to which the data belongs, based simply on the data's storage location. Of course, alternative approaches to indicating the mapping, such as tagging the data by adding a “phase” field, can also be implemented.

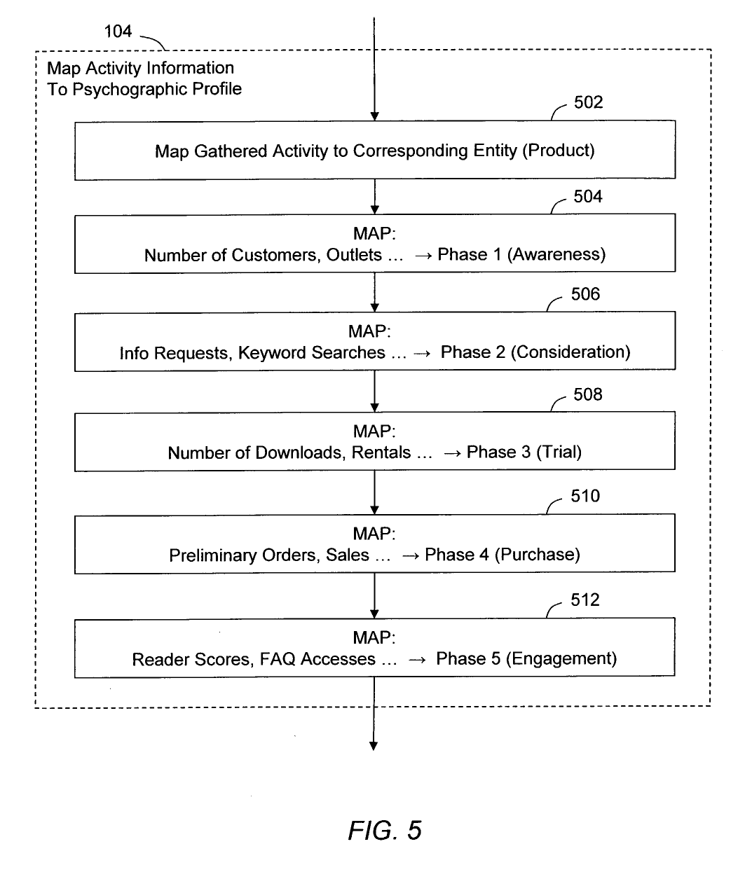

FIG. 5 illustrates some of the steps that may be included within mapping step 104 (FIG. 1). FIG. 5 is described in greater detail below.

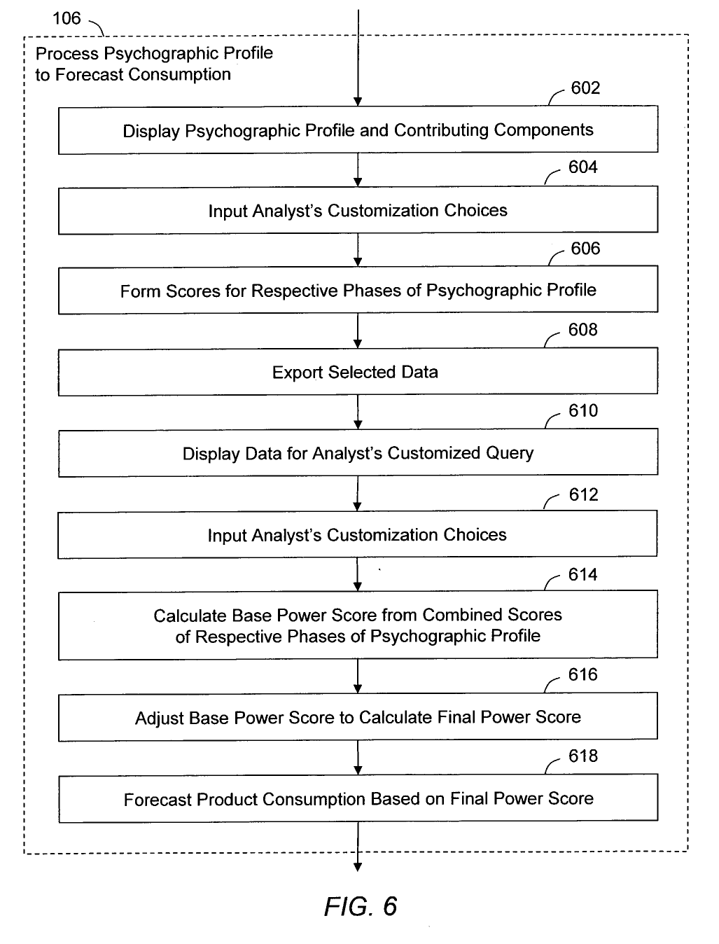

Referring again to FIG. 1, block 106 represents a step of processing the psychographic profile from step 104, to forecast consumption of the product or other entity. FIG. 6 illustrates some of the steps that may be included within an implementation of step 106.

FIG. 6 is described in greater detail below. However, briefly, the processing step 106 may optionally include displaying to an analyst, the psychographic profile 210 (see example in FIG. 2) and its contributing components (see FIG. 5) and relevant data. The analyst may review the profile and its contributing components and relevant data, and, based on his review and analysis, the analyst may customize the way in which the processing is carried out.

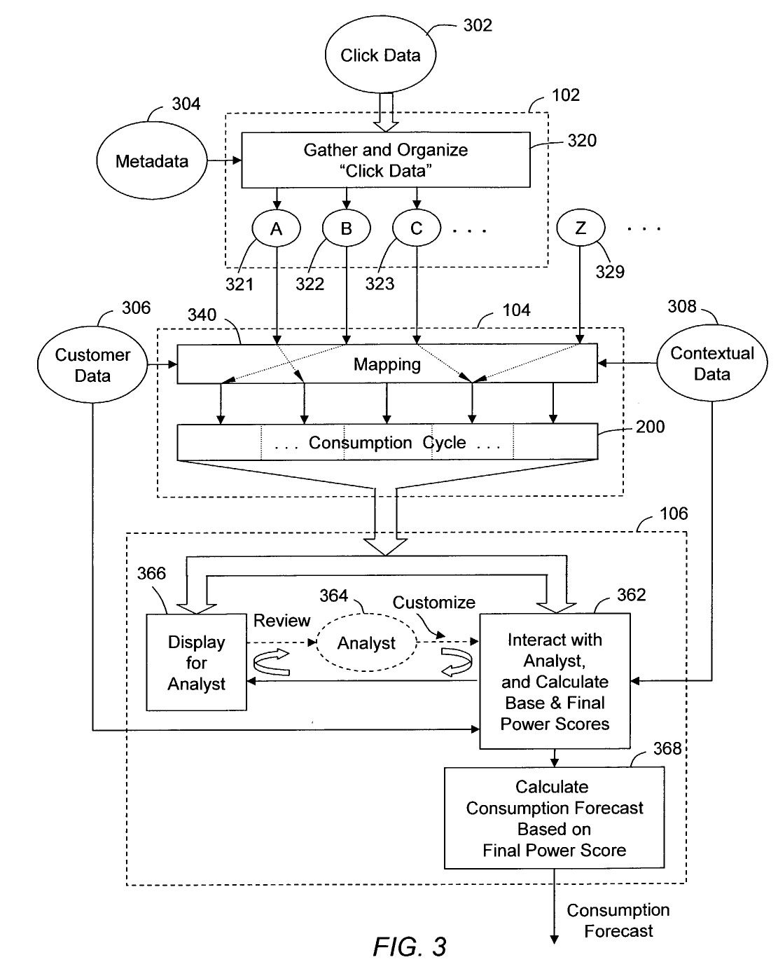

Regardless of whether or not an analyst customizes processing of a particular psychographic profile, processing step 106 includes combining scores of data mapped to the various phases of the consumption cycle, to arrive at a combined value or score, which may be referred to as a “power score.” The power score determines the forecast of consumption of the product, product category, or other entity being studied. In one embodiment, a base power score is formed, but is then refined to form a final power scored (see discussion of FIGS. 3 and 6) from which the forecast is determined.

FIG. 3 illustrates a data flow diagram corresponding to an embodiment of the method shown in FIG. 1. More specifically, FIG. 3 blocks 102, 104, 106 are processes that correspond to information gathering step 102, mapping step 104 and processing step 106 (FIG. 1).

The processes input and output data as indicated in FIG. 3. Data types shown in FIG. 3 include:

Click data 302

Metadata 304

Customer data 306

Contextual data 308

Click data 302 most closely resembles “raw data” in the common understanding of the term, in that it generally does not enter the “control inputs” of any processes. In contrast, metadata 304, customer data 306 and contextual data 308, while being collected over time, differ from click data in that they generally are generally received at the “control inputs” of processes. Of course, it is understood that the distinction between “raw data” and “control input data” is artificial, and that particular types of data (for example, data representing editorials about a product) can be used either as raw data or as control data or as both.

In any event, data of the foregoing data types may be described as follows.

“Click data” 302 data refers to data points derived or inferred from actions that are initiated by a customer in relation to a specific product or other entity, usually via an interactive online application on an Internet web site. Click data may be data of the type shown in and described with respect to FIG. 4, and described in detail below.

“Metadata” 304 may be any data that relates to objective, standardized attributes of the product or other subject, such as (in the example of a video game or computer game):

Name

Developer

Publisher or manufacturer

Category

Release date

Platform

Features (number of players, online capability, etc.)

System requirements

Franchise

License

Of course, the particular elements of the metadata depend on the characteristics of the product or other entity under consideration; the listed metadata elements are illustrative, non-limiting examples.

“Customer data” 306 is data that pertains to specific, individual customers. Normally, the customers under consideration are individuals who visit web sites that are monitored for the click data 302 they generate. In one embodiment, customer data 306 includes:

demographic data

session data

click history data

consumption cycle history data

all the data points that may be inferred from the demographic, session, click history, and consumption cycle history data (for example, product or brand preferences, purchase patterns, and so forth)

Customer data 306 may be gathered as follows.

A unique customer identifier (customer ID) such as a conventional “cookie” is placed on all browsers accessing the site.

A customer ID record, created by registration, contains demographic data such as age, gender, and ZIP code. The cookie is mapped to a customer ID record, if it has previously been created. If the customer is not already registered, this mapping is not possible, and a new anonymous customer ID record is created.

For all future sessions from each browser, click data is stored in the appropriate unique ID record, including information such as products accessed, clicks by type (for example, editorial, download, hint), and time of the monitored activity. If a particular customer is registered, additional data (for example, message board postings, product ratings, tracked product history, purchased product history) may also be gathered and stored.

After customer data 306 has thus been gathered, the monitoring and forecasting arrangement may use the customer data in a variety of ways, for example:

To create views that show an individual's or group's history and preferences at any point in time, and over time.

To allow consumption cycle data and trends to be overlaid against demographics (for example, to visually show a correlation of how a given product is tracking against customers of a certain gender and age group).

To determine current and future demand among specific demographic sets (for example, how will a given computer game sell in the Southeast vs. the West Coast, among older gamers vs. younger games, to players of Game X vs. Game Y)

“Contextual data” 308 is data, related to a specific product, that provides a context for that product in terms of various categories. Contextual data 308 may include:

Editorial data (for example, the number of editorial outlets that have covered a product, and the time and type of coverage generated)

Review or scoring data (for example, data regarding the score or grade given to a product by individual outlets, or an aggregate of data from many outlets)

Advertising/marketing data (for example, relating to the quantity, timing, placement, and type of promotions run on various media and marketing vehicles)

Sales data (for example, historical data regarding the number of units sold of a specific product)

Public relations (PR) data (for example, data relating to the quantity, timing of PR-related programs and efforts)

With this background understanding of click data 302, metadata 304, customer data 306, and contextual data 308, the data flow diagram of FIG. 3 is now described.

Referring to FIG. 3, click data 302 is gathered and organized by element 320 within information gathering process 102. The click data is organized at least in part according to the metadata 304 of the respective entities (products) being monitored. Correlating the click data to corresponding products ensures that subsequent analysis of the click data by processes 104, 106 is carried out on the proper products.

FIG. 3 elements 321, 322, 323 represent examples of click data that has been organized by product and by click data type. For example, organized data element 321 may be the number of keyword searches performed, organized data element 322 may be the number of unique customers accessing product information, and organized data element 323 may be the number of sales made over the web site. These types of click data are described in greater detail with reference to FIG. 4.

FIG. 3 element 329 represents organized data from sources other than Internet web sites. For example, organized data element 329 may be actual sales numbers from brick-and-mortar (non-Internet) distributors. Of course, the data is organized by product metadata to correspond to the entity (product) sold.

Organized data elements 321, 322, 323, 329 are input to mapping operator 340 within mapping process 104. Each element of organized data is mapped to a phase of consumption cycle 200 (see FIG. 2). The organized data 321, 322, 323, 329 thus contribute to formation of a psychographic profile 210 (FIG. 2) with respect to the entity (product) being studied. In one embodiment, the consumption cycle is merely a default consumption cycle; a customized consumption cycle may be defined by the analyst 364, as described below.

The mapping of the organized data may be governed by both customer data 306 and by contextual data 308. Customer data 306 and contextual data 308 may supplement any default mapping assignments in mapping operator 340. The particular content of a customer's customer data 306, or the semantic content of the contextual data 308, may determine, for example, whether a customer's viewing of a product simulation should be considered part of the consideration phase or the trial phase of the consumption cycle 200 (FIG. 2).

Further, an analyst 364 (described below) may employ customer data 306 and contextual data 308 to design customized consumption cycles. For example, the analyst may want to design a customized consumption cycle that is a subset or superset of a default consumption cycle (example: 200 in FIG. 2), or a more complex creative organization of data types, grouped according to the analyst's own choices and preferences.

In any event, the data that has been mapped to a phase of the consumption cycle is used by calculation process 106. Calculation process 106 involves a sub-process 362 that causes information to be displayed by a sub-process 366 to an analyst 364, who may provide customization inputs to sub-process 362. Thus, calculation process 106 may involve interaction with an analyst to calculate a “base power score” and a “final power scores.” The base and final power scores may each be referred to as a “power score.”

Briefly, the “base power score” may be determined by selectively weighting items of data of types 302, 304, 306, 308. The “final power score” may be determined by adjusting the base power score by multiplying by a series of factors or adding a series of terms. Finally, sub-process 366 uses the final power score to essentially determine the consumption forecast for the entity (product) under study.

Referring more specifically to FIG. 3, the values corresponding to phases of the consumption cycle 200 are displayed for the analyst 364 (sub-process 366) as well as being input to the calculation sub-process 362. The calculation of base and final power scores is determined in accordance with customer data 306 and contextual data 308. Customer data 306 and contextual data 308 may be loosely considered to operate as “control inputs” to sub-process 362, whereas the mapped data from mapping process 104 and the psychographic profile values conform more closely to the concept of “data” that is processed.

In any event, any relevant data, especially customer data 306 and contextual data 308 but also raw click data 302 and metadata 304, may be displayed by sub-process 366. Accordingly, analyst 364 can use all this data to customize the way in which sub-process 362 calculates the base and final power scores.

For example, in viewing displayed sales data (click data) overlaid with review data (contextual data), an analyst may perceive or suspect a particular pattern emerging: sales appear to increase after a review by a certain publication type, regardless of the rating of the review. Based on this perception, the analyst can emphasize (increase the weighting) of the review factual data, yet de-emphasize (decrease the weighting) of the rating data. With this weighting choice, the power scores and consumption forecast are calculated more intelligently in blocks 362 and 368, respectively.

With the foregoing understanding of the data flow diagram of FIG. 3 as a background, reference is now made to FIGS. 4, 5, and 6 which illustrate examples of embodiments of respective steps/processes 102, 104, and 106.

FIG. 4 shows, in no particular order, various examples of activity information that may be gathered while monitoring the actions of customers:

Step 402: number of customers (preferably, the number of unique customers) accessing product-specific information over a given time period

Step 404: amount of product information (news, previews, reviews, images, specifications, features, and so forth) accessed

Step 406: number of successful keyword searches performed (on the principle that a click to information about a specific product was the result of the keyword search)

Step 408: number of individuals requesting ongoing informational updates regarding the product or subjects (called “tracking”)

Step 410: number of downloads performed

Step 412: number of video, audio or gameplay streams initiated

Step 414: number of requests for pricing information, or pre-orders

Step 416: number of message board posts and views (posting of or requests to read message-board messages relating to the product being monitored)

Step 418: number of frequently asked questions (FAQs) or hints accessed (representing access of post-purchase information, such as help files or guides)

Step 420: broadly, other product-specific activity, generally expressing that activity other than that specifically described in other steps may be monitored, so that a variety of pertinent information may be gathered from wide-ranging sources.

Although the steps in FIG. 4 are illustrated sequentially, the steps may be performed concurrently or simultaneously, depending at least on the chosen system hardware implementation. Also, certain illustrated steps may be omitted altogether in a given implementation; conversely, steps may be included in an implementation even though they are not specifically illustrated in FIG. 4.

The illustrated information gathering steps focus on web site monitoring, in part because gathering “click data” can be automated more readily than other types of information gathering. However, customer activity information may be gathered from other sources. For example, sales data gathered from brick-and-mortar (non-Internet) distributors can be included in the data that is gathered.

FIG. 5 shows, in no particular order, various steps of mapping examples of activity information to phases of a consumption cycle 200 (see FIG. 2). See further examples of activity information in FIG. 4. FIG. 5 shows the following examples of mappings:

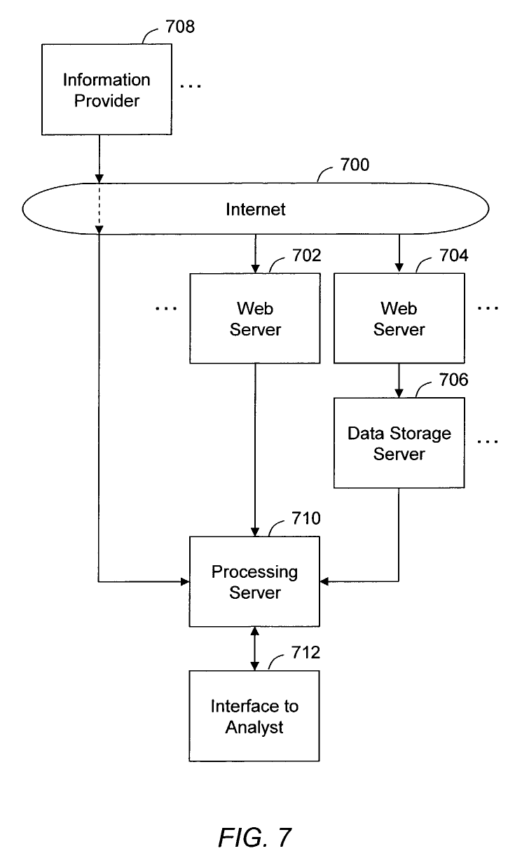

Step 502: the activity information that is gathered is mapped to a particular product so that in the ensuing analysis the data continues to be associated with that product. In one embodiment, this mapping is carried out in a processing server 710 (see FIG. 7). This mapping contrasts with the initial data organization carried out by a web server in process 320 (FIG. 3) within data gathering process 102. Third party data, such historical sales or purchase data, may also be mapped to the individual product and relevant customer interest level or phase.

Step 504: mapping the number of customers (preferably, the number of unique customers) accessing product-specific information, and number of outlets covering the product, and other information, to phase 1 of the consumption cycle (awareness phase)

Step 506: mapping the number of requests for information on the product and the number of keyword searches turning up the product, and other information, to phase 2 of the consumption cycle (consideration phase)

Step 508: mapping the number of downloads of the product (or a demonstration of the product, or a trial version of the product, and so forth) and the number of rental transactions of a product (perhaps assuming the manufacturer's goal is to ultimately sell the product), and other information, to phase 3 of the consumption cycle (trial phase)

Step 510: mapping the number of preliminary orders (or purchase requests) and the number of actual product sales, and other information, to phase 4 of the consumption cycle (purchase phase)

Step 512: mapping reviewer and reader scores (ratings) and the number of accesses of frequently asked questions (FAQs), and other information, to phase 5 of the consumption cycle (engagement phase)

Of course, FIG. 5's activity information types and consumption cycle phases are merely examples. Typically, many more types of activity information are mapped to consumption cycle phases than the two types per phase that are shown in FIG. 5.

Generally, the mappings are many-to-one mappings, in that various types of customer activities correspond to a single phase of the consumption cycle. However, it is conceivable that some mappings may be one-to-one mappings. It is also conceivable that no activities may be mapped to a particular phase, in which case any level-of-interest measurement that might otherwise be associated with that phase would not contribute to the ultimate forecast of product consumption.

Although the mapping steps in FIG. 5 are illustrated sequentially, the mapping steps may be performed concurrently or simultaneously, depending at least on the system hardware configuration. Also, certain illustrated mapping steps may be omitted altogether in a given implementation; conversely, steps may be included in an implementation even though they are not specifically illustrated in FIG. 5.

In one implementation of mapping steps 504, 506, 508, 510, 512, the mapping is accomplished by merely storing data in destination storage locations that specifically correspond to a phase of the consumption cycle. In that embodiment, the data is not “tagged” as such. Accordingly, any process that reads the stored data knows the phase to which the data belongs, based simply on the data's storage location. Of course, alternative approaches to indicating the mapping, such as tagging the data by adding a “phase” field, can also be implemented.

FIG. 6 is a flowchart detailing one embodiment of the step 106 (FIG. 1) of processing the psychographic profile to forecast future consumption of the product or other entity.

In FIG. 6, block 602 represents the optional step of displaying to an analyst any or all of various items:

the psychographic profile (example: FIG. 2).

components that have contributed to forming the psychographic profile. The contributing components may include the types of information that are gathered in step 102 (FIGS. 1, 3, 4). Displaying the contributing components permits the analyst to have a greater understanding of how the psychographic profile was formed.

other pertinent information, presented in customizable displays, that makes it easier for the analyst to understand how customer actions are affecting the psychographic profile and to decide how to favor (more heavily weight) various components or phase scores. The other pertinent information that is displayed may include click data 302, metadata 304, customer data 306, and contextual data 308 (FIG. 3).

If optional display step 602 is omitted in a particular implementation, control proceeds directly to step 606. However, if display step 602 is included in a particular implementation, control passes to block 604 which represents a step of inputting an analyst's customization choices, based the analyst's own review and analysis of the information displays.

The analyst's customization choices essentially constitute parameters that help to determine how the following portions of step 106 are carried out. For example, the analyst may specify:

time period for which the customer activity is being measured (for example, the last thirty days, last sixty days, yesterday)

a specific date or dates in the future to which the consumption forecast may apply; in this manner, the analyst may have the system forecast consumption three, six, nine, and twelve months in the future.

a product or subject set, which may be customized using fields from metadata 304 or contextual data sets 308 (described with reference to FIG. 3)

psychographic phase (for example, choosing to show results only from trial phase, or from trial and purchase phases, or for all phases)

psychographic subset (for example, choosing to show the consideration phase, but to include only information requests and keyword searches but not tracker data)

contextual data 308 (described with reference to FIG. 3)

Block 606 represents a step of forming scores for respective phases of the psychographic profile, which scores may be based on collected activity data particular to those respective phases. Generally, scores for a phase are based on plural data, reflecting that the mapping of information to phases is generally a many-to-one mapping. However, it is conceivable that some phase scores may be based on a single piece of information or type of information, reflecting that some mappings may be one-to-one mappings. It is also conceivable that some phases in some consumption cycles may have no scores, reflecting the situation in which no activities are mapped to that particular phase. The phase scores constituting the psychographic profile may be included with the other data (click data 302, metadata 304, customer data 306, and contextual data 308) in subsequent calculation steps.

Block 608 represents an optional step of exporting selected data from one analysis computer system to another. If the exporting step is included, then subsequent processing can take place at a remote location, perhaps at a different company. Exporting thus allows one company to develop a comprehensive database, and sell all or selected parts of the database to client companies who may use the exported data for their own analysis. In this event, the client company is placed in the position of analyst 364 (FIG. 3).

Data may be exported in formats suitable for the destination computer system's calculation processes, such as tab- or comma-delimited formats. The data exporting step can take place at other points in the flowchart of FIG. 6, for example after step 610 or step 612.

Block 610 represents a step of displaying data, to permit customized query and customization by an analyst. The display may include individual graphs, tables, or text, or combinations thereof. Events such as editorial coverage, advertising campaigns, marketing events, launch dates, and so forth, may be graphically overlaid on the customer activity data. This graphical overlay allows the analyst to perceive correlations between these events and customer activity that may result from the events.

More generally, data from multiple sources may be assembled into a single composite view that summarizes the state of customer interest in a product. This information may be presented in multiple ways, including:

in automated graphical reports,

as raw text,

in charts and graphs, and

in analyst-customized exports of particular data sets

Data may be viewed for any product, with the data set being viewed representing activity over any period of time. Data from multiple products can be compared to gauge relative levels of interest. Multiple products may be grouped, and that group data compared to other products or product groups. Products groups may be created using products' attributes or a combination of products' attributes.

Block 612 represents a step of inputting the analyst's further customization choices. These customization choices may differ from those entered in step 604 in that they benefit from the additional or refined knowledge made possible by processing that has occurred in steps subsequent to step 604, such as the processing required for forming phase scores in step 606.

As explained with reference to FIG. 3, the display of information in process 366 and the analyst's input of customization choices to process 362 is an interaction that may be continued indefinitely.

Block 614 represents a step of calculating a “base power score” that may be based in part on a combination of the scores from the psychographic profile from respective phases in the consumption cycle (see FIG. 2). Generally, this calculation involves a sum of weighted scores from respective psychographic profile phases. The base power score is generally based on combinations (for example, sums) of this and other weighted data. This other weighted data includes click data 302, metadata 304, customer data 306, and contextual data 308.

The base power score may be a simple linear combination of the psychographic profile's values and other data, with the weightings determined automatically by default settings or customized by analyst input.

In one embodiment, each product (such as a computer game) in a defined competitive set (a set of competing products) may be ranked in each relevant phase of the psychographic profile and in each data type. Rankings may involve assigning an integer to a product, with a lower number indicating a more popular product. A ranking of “1” would indicate the product constitutes the most popular product in the competitive set; a ranking of “2” would indicate the product constitutes the second most popular product in the competitive set, and so forth. The rankings for the product are combined by a suitable combination scheme, such as an arithmetic sum of weighted rankings, to create the base power score for the product.

Block 616 represents a step of creating final power score by using algorithms to adjust the base power score to account for additional factors deemed to be relevant. Such additional factors may include:

Target platform installed base (for example, what is the number of PlayStation 2s (PS2s) in the market, assuming the product in question operates on PS2s)

Previous history of the category to which the product belongs (for example, sports games sell better than shooter games)

Previous history of a franchise (for example, Mario games tend to sell better than other games)

“Halo effect” of a product license (for example, a game that is based on a movie, celebrity, or television show tends to sell well)

Impact of contextual data points (for example, data relating to advertising, public relations campaigns, distribution)

Competitive set (for example, games that are competitive in terms of category, release date, or customer interest tend to have similar sales potential)

Adjusting the base power score may involve adding terms and/or applying multipliers to the base power score. The base power score, summed with its added terms and/or multiplied by all its multipliers, forms the final power score.

Step 618 represents a step of providing a forecast of product consumption, the forecast being based on the final power score” from step 616. Whereas the power scores may be unit less abstract values, the consumption forecast is expressed in units appropriate to the product, product category, or other entity being studied. For example, a consumption forecast may constitute a specific number of units of a computer game sold during a given month in the future.

Referring now to FIG. 7, a system on which the foregoing methods may be implemented is provided. Connected to the Internet 700 (or other suitable network from which information is gathered) are one or more web servers shown schematically as elements 702, 704. Web servers 702, 704 gather information from information sources such as web sites on Internet 700, thus performing step 102 (FIGS. 1, 3, 4). Information from other sources, schematically indicated as information provider 708, may also be gathered.

Web server 702 gathers information and sends it directly to a processing server 710. In an alternative arrangement, web server 704 sends data to a data storage server 706 before the data is forwarded to the processing server 710. In still another arrangement, information provider 708 provides information directly to the processing server 710 via a suitable communications path, such as Internet 700. Processing server 710 receives data gathered by sources 702, 704/706, 708, and other sources not shown, and carries out mapping step 104 (FIGS. 1, 3, 5) and calculation step (FIGS. 1, 3, 6). Analyst 364 (FIG. 3) interacts with the processing server 710 by a suitable interface 712.

As one example of the system, one implementation of the various individual servers in FIG. 7 are described:

Element 702 may be implemented as plural web servers that perform different respective functions. In one approach, a first web server collects various data types (click data 302, metadata 304, customer data 306, and contextual data 308) and may be a Dual Pentium IV 1.2 GHz machine (2 GB RAM, 36 GB hard drive, running on Windows 2000 Server) using SQL Server 2000 to automatically synchronize data with processing server 710, the data gathering code being written in ASP (VBScript). A second web server collects only click data, and may be include Compaq dl 380s (quad Xeon 2.8 GHz, 2 GB RAM, 36 GB hard drives running Windows 2000 Server) and using Sybase, the data gathering code being written in ASP (VBScript), with the processing server reading the data nightly.

Web server 704 may be a Quad Xeon 2.8 GHz Compaq dl 380 (actually, four servers, with 2 GB RAM, 36 GB hard drives, running on Linux and using MYSQL), the data gathering code being implemented in PHP. Data in the form of text files is sent nightly to data storage server 706.

Data storage server 706 may be a dual Pentium IV 1.2 GHz machine (1 GB RAM, 72 GB hard drive, running on Linux). Data storage server does not perform any of the functions 102, 104, 106 (FIG. 1) but serves as an intermediate storage location for data from web server 704.

Information provider 708 may be a brick-and-mortar (non-Internet) distributor providing product sales numbers by automated or manual data entry.

Processing server 710 performs the mapping and calculation steps/processes 104, 106 (FIGS. 1, 3). Processing server may be Compaq dl 380s (quad Xeon 2.8 GHz, 2 GB RAM, 72 GB hard drive, running on Windows 2000 Server) and using SQL Server, the mapping and calculation code being written in ASP and PHP. Interface 712 may be conventional in design, and may include a monitor, speakers, keyboard, mouse, and the like.

The servers of the present invention may be distributed differently than as presented in FIG. 7 in given applications, for considerations such as performance, reliability, cost, and so forth.

More generally, the various computers shown in FIG. 7 may be implemented as any appropriate server employing technology known by those skilled in the art to be appropriate to the functions performed. A server may be implemented using a conventional general purpose computer programmed according to the foregoing teachings, as will be apparent to those skilled in the computer art. Appropriate software can readily be prepared by programmers of ordinary skill based on the teachings of the present disclosure, as will be apparent to those skilled in the software art. Other suitable programming languages operating with other available operating systems may be chosen.

General purpose computers may implement the foregoing methods, in which the computer housing may house a CPU (central processing unit), memory such as DRAM (dynamic random access memory), ROM (read only memory), EPROM (erasable programmable read only memory), EEPROM (electrically erasable programmable read only memory), SRAM (static random access memory), SDRAM (synchronous dynamic random access memory), and Flash RAM (random access memory), and other special purpose logic devices such as ASICs (application specific integrated circuits) or configurable logic devices such GAL (generic array logic) and reprogrammable FPGAs (field programmable gate arrays).

Each computer may also include plural input devices (for example, keyboard, microphone, and mouse), and a display controller for controlling a monitor. Additionally, the computer may include a floppy disk drive; other removable media devices (for example, compact disc, tape, and removable-magneto optical media); and a hard disk or other fixed high-density media drives, connected using an appropriate device bus such as a SCSI (small computer system interface) bus, an Enhanced IDE (integrated drive electronics) bus, or an Ultra DMA (direct memory access) bus. The computer may also include a compact disc reader, a compact disc reader/writer unit, or a compact disc jukebox, which may be connected to the same device bus or to another device bus.

As stated above, the system includes at least one computer readable medium. Examples of computer readable media include compact discs, hard disks, floppy disks, tape, magneto optical disks, PROMs (for example, EPROM, EEPROM, Flash EPROM), DRAM, SRAM, SDRAM).

Stored on any one or on a combination of computer readable media is software for controlling both the hardware of the computer and for enabling the computer to interact with a human user, to perform the functions described above. Such software may include, but is not limited to, user applications, device drivers, operating systems, development tools, and so forth.

Such computer readable media further include a computer program product including computer executable code or computer executable instructions that, when executed, causes a computer to perform the methods disclosed above. The computer code may be any interpreted or executable code, including but not limited to scripts, interpreters, dynamic link libraries, Java classes, complete executable programs, and the like.

From the foregoing, it will be apparent to those skilled in the art that a variety of methods, systems, computer programs on recording media, and the like, are provided.

For example, there is provided a method of monitoring activity of customers with reference to an entity in order to enable a forecast of future consumption of the entity. The method includes steps of gathering activity information that characterizes the activity of the customers with reference to the entity, mapping the gathered activity information to a psychographic profile that represents a level of interest of the customers as a function of corresponding phases of a consumption cycle, and processing at least the mapped activity information to formulate the forecast of future consumption of the entity.

The entity may be a commercial product; and consumption of the product may include purchase, rental or use of the commercial product.

The entity may be an electronic product selected from a group including a video game, a computer game, a computer program, and an electronic file; and consumption of the electronic product may include purchase, rental or use of the electronic product.

The entity may be a category of plural products; and consumption of the entity may include purchase, rental, use or interest in at least one of the plural products in the category.

The entity may be an abstract topic, and consumption of the product may include the customers' interest in the abstract topic.

The activity information gathering step may include characterizing activity of the customers on at least one Internet web site.

The phases of the consumption cycle, to which the activities of the customers are mapped, may include an awareness phase, a consideration phase, a trial phase, a purchase phase, and an engagement phase.

The processing step may include weighting scores of information contributing to the psychographic profile in corresponding phases of the consumption cycle, combining the weighted scores so as to form a power score, and determining the forecast of future consumption based on the power score.

At least one of the mapping and processing steps includes outputting data representing the level of interest of the customers, and receiving customization parameters that at least partially govern the mapping and processing steps.

The method may further include gathering control data including at least one of a group including (1) click data representing customer activity on an Internet web site, (2) metadata representing entity attributes, (3) customer data representing attributes of customers or customers' respective activities, and (4) contextual data representing contexts of entities; and at least one of the mapping and processing steps may include using the control data to map the gathered activity information or to process at least the mapped activity information, respectively.

At least one of the mapping and processing steps may include outputting the control data, and receiving customization parameters that at least partially govern the mapping and processing steps.

Also provided is a computer program product storing program instructions for execution on a computer system having at least one data processing device, which instructions when executed by the computer system cause the computer system to perform any of the foregoing methods.

Also provided is a system for monitoring activity of customers with reference to an entity in order to enable a forecast of future consumption of the entity. The system may include a first portion configured to gather activity information that characterizes the activity of the customers with reference to the entity, a second portion configured to map the gathered activity information to a psychographic profile that represents a level of interest of the customers as a function of corresponding phases of a consumption cycle, and a third portion configured to process at least the mapped activity information to formulate the forecast of future consumption of the entity.

The first portion may include at least a web server computer configured to gather the activity information from at least one Internet web site, and the second and third portions may be included within a processing computer that is configured to receive the gathered activity information from the web server computer.

The system may further include an interface configured to allow an analyst to interact with the second computer to interactively customize at least one of (a) mapping of the gathered activity information and (b) processing the mapped activity information.

The foregoing embodiments are merely examples and are not to be construed as limiting the invention. The description of the embodiments is intended to be illustrative, and not to limit the scope of the claims. Many alternatives, modifications, and variations will be apparent to those skilled in the art in light of the above teachings. For example, the choice of different hardware arrangements, software implementations, instruction execution schemes, data types, data structures, and so forth, lie within the scope of the present invention. It is therefore to be understood that within the scope of the appended claims and their equivalents, the invention may be practiced otherwise than as specifically described herein.

1. A method of monitoring activity of customers with reference to an entity in order to enable a forecast of future consumption of the entity, the method comprising:
gathering activity information that characterizes the activity of the customers with reference to the entity; and
mapping the gathered activity information to a profile that represents a level of interest of the customers as a function of corresponding phases of a consumption cycle.

2. The method of claim 1, wherein:
the entity is a commercial product; and
consumption of the product includes purchase, rental or use of the commercial product.

3. The method of claim 2, wherein:
the entity is an electronic product selected from a group including a video game, a computer game, a computer program, and an electronic file; and
consumption of the electronic product includes purchase, rental or use of the electronic product.

4. The method of claim 1, wherein:
the entity is a category of plural products; and
consumption of the entity includes purchase, rental, use or interest in at least one of the plural products in the category.

5. The method of claim 1, wherein:
the entity is an abstract topic; and
consumption of the product includes the customers' interest in the abstract topic.

6. The method of claim 1, wherein the activity information gathering step includes:
characterizing activity of the customers on at least one Internet web site.

7. The method of claim 1, wherein the phases of the consumption cycle, to which the activities of the customers are mapped, include:
an awareness phase;
a consideration phase;
a trial phase;
a purchase phase; and
an engagement phase.

8. The method of claim 16, wherein the processing step includes:
weighting scores of information contributing to the profile in corresponding phases of the consumption cycle;
combining the weighted scores so as to form a power score; and
determining the forecast of future consumption based on the power score.

9. The method of claim 16, wherein at least one of the mapping and processing steps includes:
outputting data representing the level of interest of the customers; and
receiving customization parameters that at least partially govern the mapping and processing steps.

10. The method of claim 16, wherein:
a) the method further comprises gathering control data including at least one of a group including:
1) click data representing customer activity on an Internet web site;
2) metadata representing entity attributes;
3) customer data representing attributes of customers or customers' respective activities; and
4) contextual data representing contexts of entities; and
b) at least one of the mapping and processing steps includes using the control data to map the gathered activity information or to process at least the mapped activity information, respectively.

11. The method of claim 10, wherein at least one of the mapping and processing steps includes:
outputting the control data; and
receiving customization parameters that at least partially govern the mapping and processing steps.

12. A computer program product storing program instructions for execution on a computer system having at least one data processing device, which instructions when executed by the computer system cause the computer system to perform the method of any of claims 1-11, 16.

13. A system for monitoring activity of customers with reference to an entity in order to enable a forecast of future consumption of the entity, the system comprising:
a first portion configured to gather activity information that characterizes the activity of the customers with reference to the entity; and
a second portion configured to map the gathered activity information to a profile that represents a level of interest of the customers as a function of corresponding phases of a consumption cycle.

14. The system of claim 17, wherein:
the first portion includes at least a web server computer configured to gather the activity information from at least one Internet web site; and
the second and third portions are included within a processing computer that is configured to receive the gathered activity information from the web server computer.

15. The system of claim 14, further comprising:
an interface configured to allow an analyst to interact with the second computer to interactively customize at least one of (a) mapping of the gathered activity information and (b) processing the mapped activity information.

16. The method of claim 1, further comprising:
processing at least the mapped activity information to formulate the forecast of future consumption of the entity.

17. The system of claim 13, further comprising:
a third portion configured to process at least the mapped activity information to formulate the forecast of future consumption of the entity.
